(19) United States
(12) Patent Application Publication
(10) Pub. No.: US 2026/0307265 A1
(43) Pub. Date: Oct. 8, 2026

(54) ROBOT SYSTEM, CONTROL DEVICE THEREFOR, CONTROL METHOD, AND CONTROL PROGRAM

(71) Applicant: FANUC CORPORATION, Minamitsuru-gun, Yamanashi (JP)

(72) Inventors: Mikito HANE, Yamanashi (JP); Tadanori SUZUKI, Yamanashi (JP)

(73) Assignee: FANUC CORPORATION, Minamitsuru-gun, Yamanashi (JP)

(21) Appl. No.: 19/481,229

(22) PCT Filed: Jun. 28, 2023
(86) PCT No.: PCT/JP2023/023940

§ 371 Date: Nov. 4, 2025

(51) Int. Cl. B25J 9/16; B25J 11/00; B25J 13/08; B25J 15/00

(52) U.S. Cl. CPC B25J 9/1697; B25J 11/0065; B25J 13/085; B25J 15/0019

(57) ABSTRACT

A robot system includes a tool that performs prescribed machining on a workpiece, a robot that moves the tool relative to the workpiece, a camera that acquires a first image of a machining mark formed on the workpiece as a result of the machining, and a control device. The control device includes at least one memory and at least one processor. The memory stores a plurality of second images of machining marks formed when the machining is performed while switching parameters relating to a relative orientation of the workpiece and the tool, in association with the parameters. The processor compares the first image and the second images, thereby estimating a parameter corresponding to the machining mark in the first image.

### TECHNICAL FIELD

The present disclosure relates to a robot system, a control device therefor, a control method, and a control program.

### BACKGROUND

There is a known robot system including: a grinding device for grinding an object; and a robot that adjusts the orientation of the grinding device on the basis of the rotation speed and current value of a drive unit of the grinding device (for example, see Japanese Unexamined Patent Application, Publication No. 2022-065378).

### SUMMARY

An aspect of the present disclosure is a robot system including a tool that performs prescribed machining on a workpiece, a robot that relatively moves the tool and the workpiece, a camera that acquires a first image of a machining mark formed on the workpiece as a result of the machining, and a control device, wherein: the control device includes at least one memory and at least one processor; the memory stores a plurality of second images of machining marks formed when the machining is performed while switching parameters relating to a relative orientation of the workpiece and the tool, in association with the parameters; and the processor compares the first image and the second images, thereby estimating a parameter corresponding to the machining mark in the first image.

### BRIEF DESCRIPTION OF DRAWINGS

FIG. 1 is a perspective view showing a robot system according to an embodiment of the present disclosure.

FIG. 2 is a partially enlarged view showing the orientation of a tool during machining by the robot system in FIG. 1.

FIG. 3 is a schematic diagram showing the surface of a workpiece polished by the robot system in FIG. 1.

FIG. 4 is a schematic diagram showing a first image acquired by a camera of the robot system in FIG. 1.

FIG. 5 is a block diagram showing the configuration of a control device according to an embodiment of the present disclosure.

FIG. 6 is a schematic diagram showing a second image stored in a memory of the control device in FIG. 5.

FIG. 7 is a schematic diagram showing a second image stored in the memory of the control device in FIG. 5.

FIG. 8 is a schematic diagram showing a second image stored in the memory of the control device in FIG. 5.

FIG. 9 is a flowchart showing a control method performed by the control device in FIG. 5.

FIG. 10 is a schematic diagram showing a first image in a case in which the tool is tilted about an X-axis.

### DETAILED DESCRIPTION OF EMBODIMENTS

A robot system 1, a control device 10, a control method, and a control program according to an embodiment of the present disclosure will be described below with reference to the drawings.

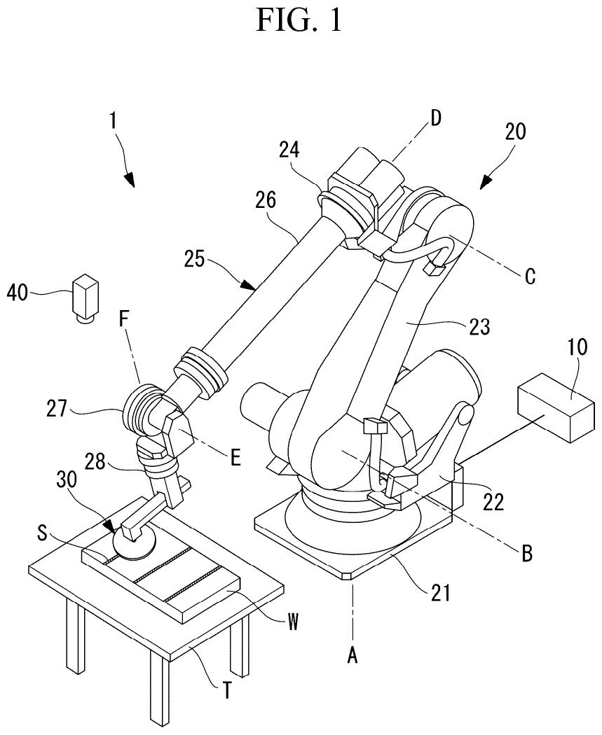

As shown in FIG. 1, the robot system 1 according to this embodiment includes: a robot 20 that performs prescribed work; a tool 30 attached to the distal end of the robot 20; and a camera 40 disposed outside the robot 20. In addition, the robot system 1 is provided with the control device 10 according to this embodiment for controlling the robot 20, the tool 30, and the camera 40.

As shown in FIG. 1, the robot 20 is, for example, a six-axis vertical articulated robot.

The robot 20 includes: a base 21 that is installed on an installation surface, such as a horizontal floor; and a revolving drum 22 that is rotatable about a vertical first axis A with respect to the base 21. In addition, the robot 20 includes: a first arm 23 that is rotatable about a horizontal second axis B with respect to the revolving drum 22; and a second arm 24 that is rotatable with respect to the first arm 23 about a third axis C parallel to the second axis B. Furthermore, the robot 20 includes a three-axis wrist unit 25 that is supported at the distal end of the second arm 24.

The wrist unit 25 includes a first wrist element 26 that is rotatable with respect to the second arm 24 about a fourth axis D extending along a plane orthogonal to the third axis C. In addition, the wrist unit 25 includes a second wrist element 27 that is rotatable with respect to the first wrist element 26 about a fifth axis E orthogonal to the fourth axis D. Furthermore, the wrist unit 25 includes a third wrist element 28 that is rotatable with respect to the second wrist element 27 about a sixth axis F orthogonal to the fifth axis E and passing through an intersection of the fourth axis D and the fifth axis E.

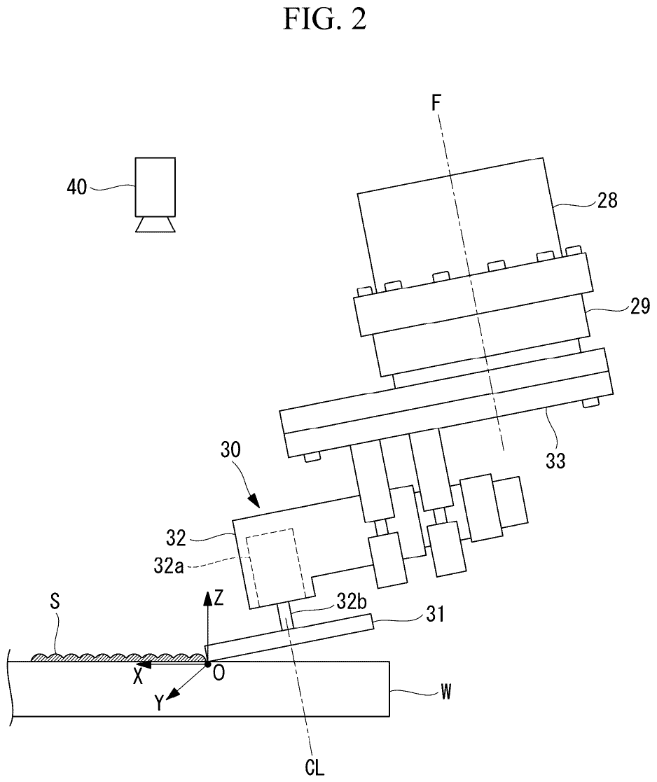

As shown in FIG. 2, the tool 30 is attached to the distal end of the third wrist element 28 with a force sensor 29 interposed therebetween. The force sensor 29 is, for example, a six-axis sensor, and detects three force components, in three orthogonal axis directions, acting on the tool 30 and three torque components about the respective axes.

In this embodiment, the tool 30 is a grinder. For example, as shown in FIG. 1, the tool 30 performs polishing on one or more welding marks S formed in a convex shape on the surface of a flat plate-shaped workpiece W installed on a work table T. In this case, the force sensor 29 detects a reaction force when the tool 30 comes into contact with the surface of the workpiece W during the polishing.

In an example shown in FIG. 2, the tool 30 includes a disk-shaped grindstone 31 and a body portion 32 that supports the grindstone 31 so as to be rotatable about a central axis CL.

The body portion 32 has a shape having a longitudinal axis, and the base end side thereof is supported in an orientation in which the longitudinal axis is orthogonal to the sixth axis F by means of a bracket 33 fixed to a side surface of the force sensor 29 on the side opposite to the third wrist element 28.

In addition, a motor 32a is mounted on the distal end side of the body portion 32. The motor 32a is provided with a shaft 32b having the grindstone 31 attached to the distal end thereof, and the shaft 32b extends in a direction orthogonal to the longitudinal axis of the body portion 32, that is, a direction parallel to the sixth axis F. In other words, the grindstone 31 is arranged in an orientation in which the central axis CL serving as the rotation center is parallel to the sixth axis F.

In addition, a tool coordinate system of three axes orthogonal to one another is defined for the tool 30. As shown in FIG. 2, the tool coordinate system has the origin O at a position farthest from the sixth axis F, on the outer circumferential edge of a lower surface of the grindstone 31, and includes an X-axis, a Y-axis, and a Z-axis orthogonal to one another at the origin O.

In the example shown in FIG. 2, the tool coordinate system defines the X-axis and the Z-axis orthogonal to each other in a plane including the central axis CL of the grindstone 31. In addition, the Z-axis is set in a direction extending in the vertical direction in a state in which the central axis CL is tilted forward by a preset reference angle with respect to the vertical direction.

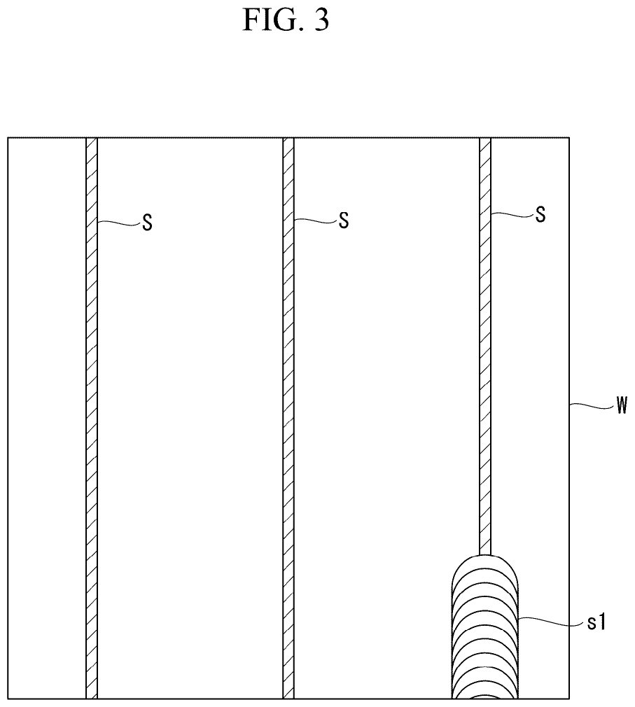

In other words, a portion of the grindstone 31 in the orientation (reference orientation) in which the grindstone 31 is tilted by the reference angle, which is located in the vicinity of the origin O, moves in the X-axis direction along the surface of the workpiece W while remaining in contact with the surface, as shown in FIG. 2, whereby the welding mark S is polished. As a result, a band-shaped polishing mark (machining mark) s1 constituted of arc-shaped polishing marks that are continuous in the X-axis direction is formed on the surface of the workpiece W, as shown in FIG. 3.

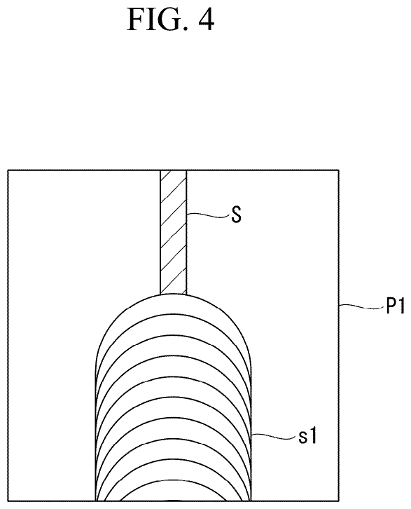

The camera 40 is, for example, a two-dimensional camera that acquires a two-dimensional image. As shown in FIGS. 1 and 2, the camera 40 is installed above the work table T so as to face downward, and captures the surface of the workpiece W within the angle of view. For example, the camera 40 can acquire a first image Pl including a welding mark S on the surface of the workpiece W and a polishing mark s1 formed when a portion of the welding mark S is polished, as shown in FIG. 4.

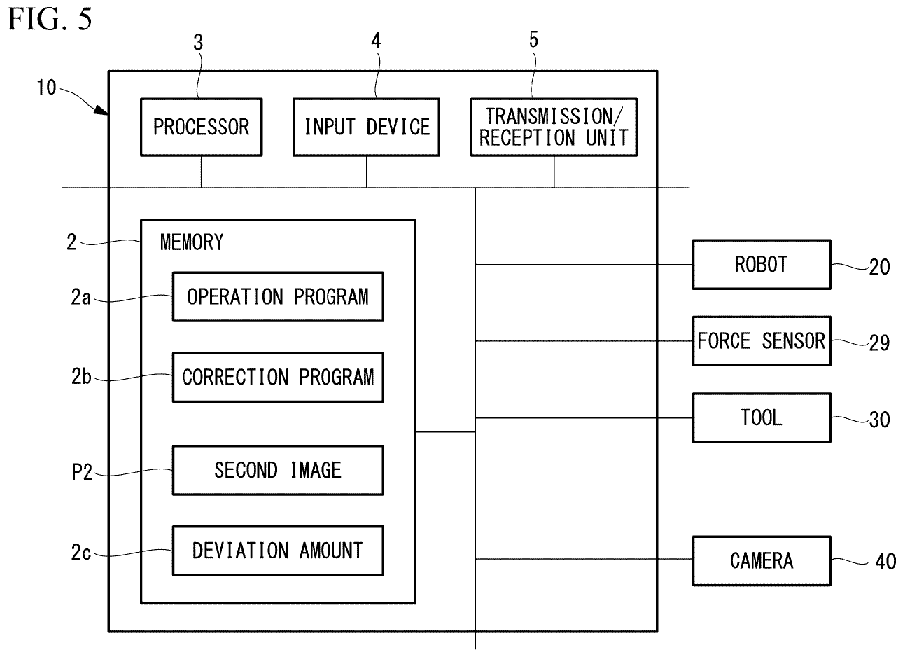

As shown in FIG. 5, the control device 10 includes: at least one memory 2 such as a ROM or a RAM; at least one processor 3 such as a CPU; an input device 4; and a transmission/reception unit 5.

The memory 2 stores an operation program 2a for controlling the operation of the robot 20 and the tool 30 when polishing the welding mark S on the surface of the workpiece W. In addition, the memory 2 stores a correction program (control program) 2b for correcting the orientation of the tool 30 during the polishing performed as a result of executing the operation program 2a. Furthermore, the memory 2 stores second images P2, which will be described later.

The operation program 2a includes a surface alignment command for bringing the entire lower surface of the grindstone 31 into contact with the surface of the workpiece W, and aligning the lower surface of the grindstone 31 with the surface of the workpiece W by means of force control based on the reaction force detected by the force sensor 29. In addition, the operation program 2a includes a command for separating, after the execution of the surface alignment, the grindstone 31 upward from the surface of the workpiece W, and setting the tool 30 to the reference orientation in which the tool 30 is tilted forward by the reference angle about the Y-axis of the tool coordinate system (see FIG. 2). Furthermore, the operation program 2a includes a command for rotating the grindstone 31 about the central axis CL while maintaining the reference orientation, and moving the portion of the grindstone 31 in the vicinity of the origin along a direction in which the welding mark S extends while bringing the portion into contact with the surface of the workpiece W.

The correction program 2b includes a group of control commands for correcting the orientation of the tool 30. For example, in a case in which slight tilting occurs between the lower surface of the grindstone 31 and the surface of the workpiece W during the alignment of the two surfaces, whereby the tool 30 is arranged in a tilted manner with respect to the reference orientation in which the tool 30 should be originally arranged, the correction program 2b corrects the orientation of the tool 30.

More specifically, the processor 3 sends a photographing command to the camera 40 on the basis of the correction program 2b, and causes the camera 40 to acquire the first image P1. Furthermore, the processor 3 receives the first image P1 from the camera 40 on the basis of the correction program 2b, and compares the first image P1 with the second images P2 (described later) stored in the memory 2. Then, on the basis of the comparison result, the tilting (deviation) with respect to the reference orientation of the tool 30 is corrected.

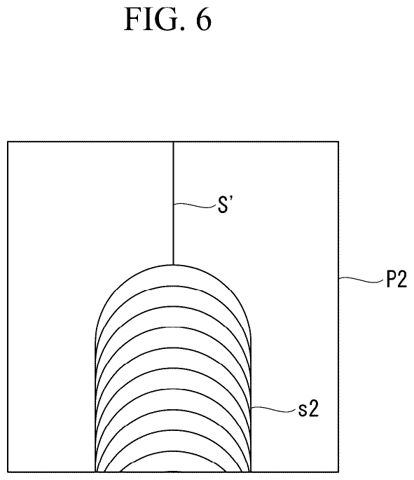

Examples of the second images P2 stored in the memory 2 are shown in FIGS. 6 to 8. The second images P2 are, for example, images acquired as a result of the camera 40 photographing a polishing mark s2 formed by the tool 30 preliminarily performing polishing on a test workpiece on which a reference line S′ corresponding to the welding mark S is drawn.

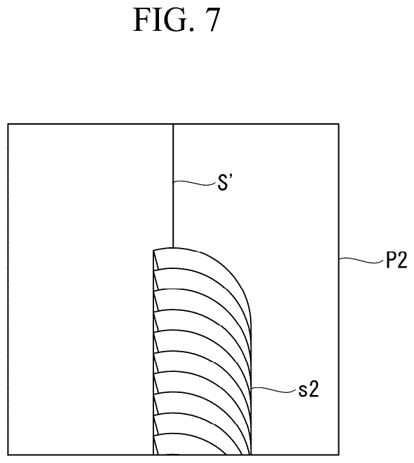

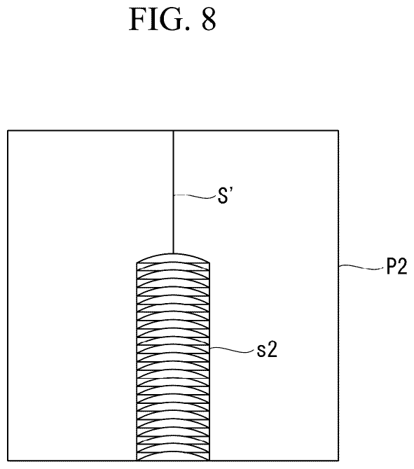

FIG. 6 shows a second image P2 of the polishing mark s2 formed by the tool 30 correctly arranged in the reference orientation. In addition, FIG. 7 shows a second image P2 in a case in which the tool 30 is tilted by a prescribed angle only about the X-axis with respect to the reference orientation, and FIG. 8 shows a second image P2 in a case in which the tool 30 is tilted by a prescribed angle only about the Y-axis with respect to the reference orientation.

The memory 2 stores angle deviation amounts (parameters) 2c about the X- , Y- , and Z-axes with respect to the reference orientation of the tool 30, corresponding to the respective second images P2, in association with the respective second images P2.

In other words, the angle deviation amounts 2c about the X- , Y- , and Z-axes being all zero are associated with the second image P2 shown in FIG. 6. Meanwhile, values that are not zero are associated with the second image P2 shown in FIG. 7 as the angle deviation amount 2c about the X-axis and with the second image P2 shown in FIG. 8 as the angle deviation amount 2c about the Y-axis.

The second image P2 is an image acquired by the camera 40 each time the tool 30 is rotated only about the X-axis, only about the Y-axis, and only about the Z-axis, at a prescribed minute angle interval for each case, and a plurality of the images are stored in the memory 2.

The processor 3 can estimate the deviation amount with respect to the reference orientation of the tool 30 by determining a second image P2 closest to the first image P1 through the comparison and reading out the deviation amount 2c associated with the second image P2. In other words, it is possible to estimate the relative orientation of the tool 30 with respect to the workpiece W.

Then, the processor 3 can obtain a correction amount in the orientation of the tool 30 on the basis of the estimated deviation amount of the tool 30.

The input device 4 is, for example, a keyboard, a touch panel, an operator's panel, or the like, and is a device for receiving an instruction made by a worker for executing the operation program 2a or the correction program 2b. In addition, the transmission/reception unit 5 performs transmission/reception of signals individually with respect to the robot 20, the tool 30, the camera 40, etc. on the basis of the operation program 2a and the correction program 2b.

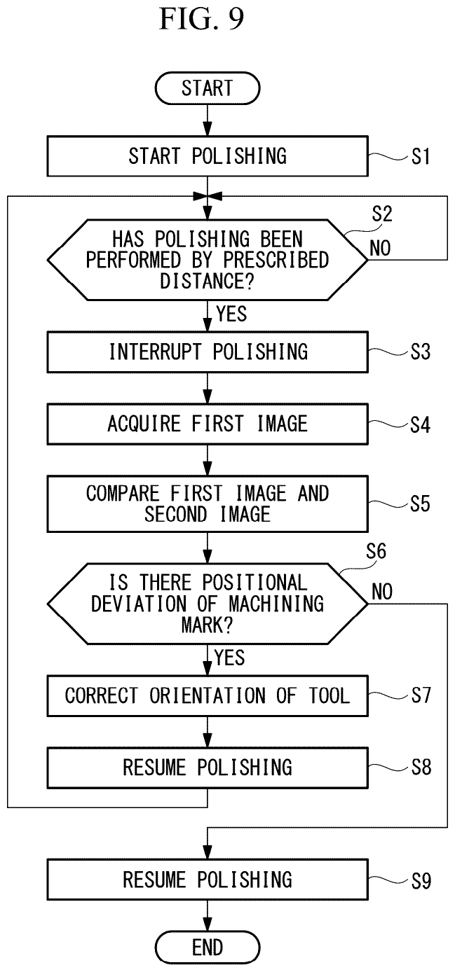

A control method performed by the control device 10 for the thus-configured robot system 1 according to this embodiment will be described along the flowchart shown in FIG. 9.

Hereinafter, as shown in FIG. 3, the case in which one of the plurality of welding marks S linearly formed on the surface of the workpiece W is polished from one end side toward the other end side will be described as an example.

First, the control device 10 for the robot system 1 according to this embodiment causes the surface alignment to be performed between the lower surface of the grindstone 31 and the surface of the workpiece W according to the operation program 2a, and subsequently causes the tool 30 to be arranged in the reference orientation. Subsequently, the control device 10 causes the grindstone 31 to be rotated about the central axis CL, and causes the portion of the grindstone 31 in the vicinity of the origin O to be brought into contact with one end of the welding mark S such that the reaction force acting on the tool 30, which is detected by the force sensor 29, achieves a prescribed magnitude (see FIG. 2). Then, from this state, the polishing of the welding mark S is started by moving the grindstone 31 along the surface of the workpiece W from the one end side toward the other end side of the welding mark S (step S1).

In the control method according to this embodiment, when it is detected that the tool 30 has moved by a prescribed distance in a direction along the X-axis after the start of the polishing (step S2), the processor 3 executes the correction program 2b. When the correction program 2b is executed, the polishing is interrupted (step S3).

Then, the control device 10 causes the camera 40 to photograph a machining mark s1 formed between the start of the polishing and the interruption, as well as a portion of the remaining welding mark S, according to the correction program 2b to acquire a first image P1 (step S4).

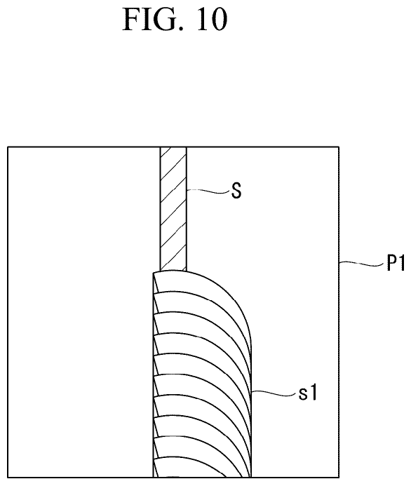

In this case, for example, in a case in which the orientation of the tool 30 is slightly deviated about the X-axis with respect to the reference orientation, the polishing mark s1 in the first image P1 is formed in a deviated manner with respect to the welding mark S serving as the target position, as shown in FIG. 10.

The first image P1 acquired by the camera 40 is transmitted to the control device 10 via the transmission/reception unit 5, and is subjected to image processing.

Then, the control device 10 compares the processed first image Pl with a plurality of second images P2 stored in advance in the memory 2, such as those shown in FIGS. 6 to 8 (step S5). Specifically, the processor 3 compares the position and shape of the polishing mark s1 with respect to the welding mark S in the first image Pl with the positions and shapes of the polishing marks s2 with respect to the respective reference lines S′ in the plurality of second images P2. Then, the second image P2 including the polishing mark s2 having a position and shape closest to those of the polishing mark s1 in the first image P1 is selected, and the deviation amount 2c stored in association with the selected second image P2 is read out from the memory 2.

When the read out deviation amount 2c is zero, that is, when the selected second image P2 is the image shown in FIG. 6, the processor 3 determines that the orientation of the tool 30 is not deviated with respect to the reference orientation (step S6). Then, when it is determined that the orientation of the tool 30 is not deviated with respect to the reference orientation, the processor 3 resumes the interrupted polishing according to the operation program 2a (step S9).

Meanwhile, when the read out deviation amount 2c is a value other than zero, that is, when the selected second image P2 is an image other than the image shown in FIG. 6, the processor 3 determines that the machining mark s1 is deviated with respect to the target position (step S6). Then, the processor 3 causes the robot 20 to operate in such a direction that the read out deviation amount 2c is cancelled, thereby correcting the orientation of the tool 30 (step S7).

Then, the polishing based on the operation program 2a is resumed in the state in which the orientation of the tool 30 is corrected (step S8), and the process returns to step S2.

Subsequently, steps S2 to S8 are repeated until the second image P2 closest to the acquired first image P1 becomes the image shown in FIG. 6. By doing so, all deviations of the tool 30 about the X- , Y- , and Z-axes are corrected. In this case, in the state in which all deviations are corrected, the polishing may be performed from the beginning or the polishing may be performed on the remaining welding mark S.

As described above, with the robot system 1, the control device 10, the control method, and the control program according to this embodiment, the orientation of the tool 30 can be corrected when the tool 30, at the time of starting the polishing, is not arranged in the reference orientation in which the tool 30 should be originally arranged. In other words, it is possible to improve the accuracy of the polishing even in a case in which the grindstone 31 of the tool 30 is a relatively soft buff or the like and the surface alignment by means of force control cannot be accurately performed.

In addition, the correction of the orientation of the tool 30 in this case is performed at the point of time when the welding mark S is polished by a prescribed distance, that is, in the early stage of the polishing; thus, it is possible to prevent the polishing from being continuously performed while the orientation of the tool 30 is deviated. Therefore, it is possible to minimize unpolished portions or the like due to the deviation in the orientation of the tool 30, and to reduce the time required for the polishing.

Note that, although the welding mark S formed on the surface of the flat plate-shaped workpiece W serves as the machining target in this embodiment, the machining target is not limited thereto. The workpiece W may have a gentle curved surface, and a welding mark or the like formed on the curved surface may serve as a machining target.

In addition, although the polishing grinder has been illustrated as an example of the tool 30 in this embodiment, the tool 30 is not limited thereto. For example, the tool 30 may be any tool that performs scraping, cutting, laser machining, or the like on a machining object.

In addition, although this embodiment has the configuration in which the polishing is performed by bringing the tool 30 attached to the distal end of the robot 20 into contact with the workpiece W installed outside, the arrangement of the workpiece W and the tool 30 may be switched. In other words, it is permissible to employ a configuration in which the polishing is performed by bringing a workpiece W attached to the distal end of the robot 20 into contact with the tool 30 fixed outside.

In addition, although the camera 40 is disposed above the work table T in this embodiment, the camera 40 may be disposed at any position so long as the surface of the workpiece W and the machining mark s1 formed thereon can be photographed. For example, the camera 40 may be attached to the wrist tip of the robot 20, and may be arranged so as to capture the portion of the grindstone 31 in the vicinity of the origin 0 within the angle of view. In this case, there is an advantage in that it is possible to photograph the polishing mark s1 formed as a result of the polishing at a closer position, thereby acquiring a first image P1 with high accuracy.

In addition, in this embodiment, the first image P1 acquired as a result of the execution of the correction program 2b and the deviation amount in the orientation of the tool 30, which is estimated on the basis of the first image P1, may be additionally stored in the memory 2. In other words, the control device 10 may store, in the memory 2 for use in the comparison, deviation amounts in association with the first image P1 acquired first after the start of the correction program 2b, the deviation amounts representing all correction amounts obtained by performing one or more rounds of correction and obtained when the deviation amount is finally eliminated. Then, the control device 10 may use a so-called machine learning function so as to be capable of estimating the deviation amounts about the X- , Y- , and Z-axes all at once from the acquired first image P1.

In addition, the orientation of the tool 30 is adjusted by operating the robot 20 in this embodiment. Alternatively, in a case in which the tool 30 itself has a drive mechanism for changing the orientation thereof, the drive mechanism of the tool 30 may be operated by an amount corresponding to the deviation amount in the orientation of the tool 30, which is estimated by the same method as described above. In this case, it is possible to correct the orientation of the tool 30 while maintaining the orientation of the robot 20.

In addition, although the control device 10 changes the orientation of the tool 30 on the basis of the estimated deviation amount in the orientation of the tool 30 in this embodiment, alternatively, the arrangement of the tool coordinate system set for the tool 30 may be changed.

For example, in a case in which the orientation of the tool 30, at the time of starting the polishing, is tilted about the X-axis with respect to the reference orientation, the tool coordinate system set for the tool 30 is reset so as to be tilted about the X-axis by the same amount as the tilting of the tool 30 and in a direction opposite to the tilting. By doing so, the robot 20 is operated with reference to the tool coordinate system tilted in such a direction that the deviation in the orientation of the tool 30 is cancelled. Therefore, the orientation of the tool 30 is corrected in the operation program 2a executed after the tool coordinate system is reset.

In addition, in this embodiment, the control device 10 may correct the deviation in the orientation of the tool 30, and may also adjust the contact pressure of the tool 30 with respect to the workpiece W on the basis of the reaction force acting on the tool 30, which is detected by the force sensor 29

With this configuration, in the polishing after the orientation of the tool 30 is corrected, it is possible to prevent the contact pressure acting on the tool 30 from being unintentionally increased and exceeding an allowable value.

In addition, this embodiment may be configured so as to adjust the correction amount in the orientation of the tool 30 according to the type of the tool 30.

For example, a plurality of second images P2 and the deviation amounts 2c of the tool 30 are associated with each other and stored in the memory 2 for each of a plurality of grindstones 31 having different grit sizes.

With this configuration, even in a case in which the grit size of the grindstone 31 is changed in the middle of the series of polishing processes, it is possible to accurately correct the orientation of the tool 30 after the change of the grindstone 31.

Similarly, this embodiment may be configured so as to adjust the correction amount in the orientation of the tool 30 according to the use period of the tool 30.

For example, a plurality of second images P2 and the deviation amounts 2c of the tool 30 are associated with each other and stored in the memory 2 for each use period, that is, for each wear state of the grindstone. With this configuration, it is possible to prevent deterioration in the accuracy of correcting the orientation of the tool 30 due to the difference in the wear state of the grindstone 31.

In addition, although the method of correcting the deviations of the tool 30 about the respective axes of the tool coordinate system has been illustrated as an example in this embodiment, it is also possible to correct positional deviations of the tool 30 in the respective axial directions by using the same method.

In addition, in this embodiment, the control device 10 controls the robot 20 so that the orientation of the tool 30 is corrected, on the basis of the estimated deviation in the orientation of the tool 30. Alternatively, the robot system 1 may include a display device, and the control device 10 may cause the display device to display the direction and amount of the estimated deviation in the orientation of the tool 30, thereby allowing a worker to correct the orientation of the tool 30.

Although the embodiments of the present disclosure have been described in detail above, the present disclosure is not limited to the individual embodiments described above. In these embodiments, various addition, replacement, alteration, partial deletion, and so forth can be made within a range that does not depart from the scope of the invention, or within a range that does not depart from the concept and spirit of the present invention derived from the content set forth in the claims and the equivalents thereof. For example, in the embodiments described above, the order of the individual operations and the order of the individual processes have been illustrated as an example, and the orders are not limited thereto.

In regard to the abovementioned embodiments and modifications, the following appended notes are further disclosed.

### Note 1

A robot system including a tool that performs prescribed machining on a workpiece, a robot that relatively moves the tool and the workpiece, a camera that acquires a first image of a machining mark formed on the workpiece as a result of the machining, and a control device, wherein: the control device includes at least one memory and at least one processor; the memory stores a plurality of second images of machining marks formed when the machining is performed while switching parameters relating to a relative orientation of the workpiece and the tool, in association with the parameters; and the processor compares the first image and the second images, thereby estimating a parameter corresponding to the machining mark in the first image.

### Note 2

The robot system according to Note 1, wherein the processor adjusts the relative orientation of the workpiece and the tool on the basis of the estimated parameter.

### Note 3

The robot system according to Note 2, further including a drive mechanism capable of changing an orientation of the tool, wherein the processor adjusts the orientation of the tool by operating the drive mechanism on the basis of the estimated parameter.

### Note 4

The robot system according to Note 2, wherein the processor adjusts an orientation of the tool by controlling the robot on the basis of the estimated parameter.

### Note 5

The robot system according to Note 4, wherein: the tool is attached to the robot; a tool coordinate system having an origin at a distal end point of the tool is set for the tool; and the processor adjusts an angle of the tool about the origin of the tool coordinate system by controlling the robot on the basis of the estimated parameter.

### Note 6

The robot system according to Note 2, wherein: the tool is attached to the robot; a tool coordinate system having an origin at a distal end point of the tool is set for the tool; and the processor adjusts an angle of the tool coordinate system about the origin of the tool coordinate system on the basis of the estimated parameter.

### Note 7

The robot system according to any one of Notes 2 to 6, wherein the processor additionally stores, in the memory, the first image and the parameter estimated for the first image in association with each other.

### Note 8

The robot system according to any one of Notes 2 to 7, wherein the memory stores the second images and the parameters in association with a type of the tool.

### Note 9

The robot system according to any one of Notes 2 to 8, wherein the memory stores the second images and the parameters in association with a use period of the tool.

### Note 10

The robot system according to any one of Notes 2 to 9, further including a sensor capable of detecting a force acting on the tool, wherein the processor adjusts a contact pressure between the workpiece and the tool during the machining on the basis of the force detected by the sensor.

### Note 11

A control device for a robot system including a tool that performs prescribed machining on a workpiece, a robot that relatively moves the tool and the workpiece, and a camera that acquires a first image of a machining mark formed on the workpiece as a result of the machining, the control device including at least one memory and at least one processor, wherein: the memory stores a plurality of second images of machining marks formed when the machining is performed while switching parameters relating to a relative orientation of the workpiece and the tool, in association with the parameters; and the processor compares the first image and the second images, thereby estimating a parameter corresponding to the machining mark in the first image.

### Note 12

A control method for a robot system including a tool that performs prescribed machining on a workpiece, a robot that relatively moves the tool and the workpiece, and a camera that acquires a first image of a machining mark formed on the workpiece as a result of the machining, the control method including: storing a plurality of second images of machining marks formed when the machining is performed while switching parameters relating to a relative orientation of the workpiece and the tool, in association with the parameters; and comparing the first image and the second images, thereby estimating a parameter corresponding to the machining mark in the first image.

### Note 13

A control program for a robot system including a tool that performs prescribed machining on a workpiece, a robot that relatively moves the tool and the workpiece, and a camera that acquires a first image of a machining mark formed on the workpiece as a result of the machining, the control program causing a computer to execute: storing a plurality of second images of machining marks formed when the machining is performed while switching parameters relating to a relative orientation of the workpiece and the tool, in association with the parameters; and comparing the first image and the second images, thereby estimating a parameter corresponding to the machining mark in the first image.

1. A robot system, comprising:
a tool that performs prescribed machining on a workpiece, a robot that moves the tool relative to the workpiece,
a camera that acquires a first image of a machining mark formed on the workpiece as a result of the machining, and
a control device, wherein:
the control device includes at least one memory and at least one processor;
the memory stores a plurality of second images of machining marks formed when the machining is performed while switching parameters relating to a relative orientation of the workpiece and the tool, in association with the parameters; and
the processor compares the first image and the second images, thereby estimating a parameter corresponding to the machining mark in the first image.

2. The robot system according to claim 1, wherein the processor adjusts the relative orientation of the workpiece and the tool on the basis of the estimated parameter.

3. The robot system according to claim 2, further comprising a drive mechanism configure to change orientation of the tool,
wherein the processor adjusts the orientation of the tool by operating the drive mechanism on the basis of the estimated parameter.

4. The robot system according to claim 2, wherein the processor adjusts an orientation of the tool by controlling the robot on the basis of the estimated parameter.

5. The robot system according to claim 4, wherein:
the tool is attached to the robot;
a tool coordinate system having an origin at a distal end point of the tool is set for the tool; and
the processor adjusts an angle of the tool about the origin of the tool coordinate system by controlling the robot on the basis of the estimated parameter.

6. The robot system according to claim 2, wherein:
the tool is attached to the robot;
a tool coordinate system having an origin at a distal end point of the tool is set for the tool; and
the processor adjusts an angle of the tool coordinate system about the origin of the tool coordinate system on the basis of the estimated parameter.

7. The robot system according to claim 2, wherein the processor additionally stores, in the memory, the first image and the parameter estimated for the first image in association with each other.

8. The robot system according to claim 2, wherein the memory stores the second images and the parameters in association with a type of the tool.

9. The robot system according to claim 2, wherein the memory stores the second images and the parameters in association with a use period of the tool.

10. The robot system according to claim 2, further comprising a sensor configured to detect a force acting on the tool,
wherein the processor adjusts a contact pressure between the workpiece and the tool during the machining on the basis of the force detected by the sensor.

11. A control device for a robot system, comprising:
a tool that performs prescribed machining on a workpiece,
a robot that moves the tool relative to the workpiece,
a camera that acquires a first image of a machining mark formed on the workpiece as a result of the machining, and
at least one memory and at least one processor, wherein:
the memory stores a plurality of second images of machining marks formed when the machining is performed while switching parameters relating to a relative orientation of the workpiece and the tool, in association with the parameters; and
the processor compares the first image and the second images, thereby estimating a parameter corresponding to the machining mark in the first image.

12. A control method for a robot system, the system comprising a tool that performs prescribed machining on a workpiece, a robot that moves the tool relative to the workpiece, and a camera that acquires a first image of a machining mark formed on the workpiece as a result of the machining,
the control method comprising:
storing a plurality of second images of machining marks formed when the machining is performed while switching parameters relating to a relative orientation of the workpiece and the tool, in association with the parameters; and
comparing the first image and the second images, thereby estimating a parameter corresponding to the machining mark in the first image.

13. A non-transitory computer-readable medium having a control program stored therein for a robot system comprising a tool that performs prescribed machining on a workpiece, a robot that moves the tool relative to the workpiece, and a camera that acquires a first image of a machining mark formed on the workpiece as a result of the machining,
the control program causing a computer to execute:
storing a plurality of second images of machining marks formed when the machining is performed while switching parameters relating to a relative orientation of the workpiece and the tool, in association with the parameters; and
comparing the first image and the second images, thereby estimating a parameter corresponding to the machining mark in the first image.
